(19) United States
(12) Patent Application Publication
(10) Pub. No.: US 2005/0207455 A1
(43) Pub. Date: Sep. 22, 2005

(54) Method and apparatus for efficient coupling of pump light into fiber amplifiers

(76) Inventors: Stuart MacCormack, Mountain View, CA (US); Dirk Kuizenga, Sunnyvale, CA (US); Bernard Fidric, Cupertino, CA (US); Hanna J. Hoffman, Palo Alto, CA (US)

Correspondence Address: HELLER EHRMAN LLP, 275 MIDDLEFIELD ROAD, MENLO PARK, CA, 94025-3506, US

(21) Appl. No.: 11/014,229

(22) Filed: Dec. 15, 2004

Related U.S. Application Data
(63) Continuation of application No. 60/529,259, filed on Dec. 15, 2003.

(51) Int. Cl. H01S 3/30

(52) U.S. Cl. 372/6

(57) ABSTRACT

A fiber amplifier is disclosed and includes a fiber amplifier body comprising a core of a first diameter, at least one signal conduit in optical communication with a signal source and the fiber amplifier body, the signal conduit sized to the first diameter, and one or more pump conduits configured to propagate pump radiation to the fiber amplifier body, the pump conduits in optical communication with at least one pump source.

### CROSS-REFERENCE TO RELATED APPLICATIONS

The present application claims priority to U.S. Provisional Patent Appl. Ser. No. 60/529,259, filed Dec. 15, 2003, the contents of which are incorporated by reference herein in its entirety.

### BACKGROUND

Presently, significant challenges remain when coupling pump light from a pump source into one or more fiber lasers or amplifiers. To date, numerous pumping and pump coupling architectures have been suggested and developed, including end-pumping and side pumping techniques. For example, an end-pumped fiber amplifier may be formed by wavelength multiplexing the optical radiation from the pump source and the signal source. In the alternative, a fiber laser or amplifier may be formed by spatial multiplexing the optical radiation from a pump source and signal source. For example, U.S. Pat. No. 5,864,644, issued to DiGiovanni et al (hereinafter DiGiovanni) teaches a configuration having a fused tapered fiber bundle configured to spatially multiplex the optical radiation from a pump source and signal source into the end facet of a double clad optical fiber. FIG. 1 shows an embodiment of this prior art approach, wherein a number of pump fibers 1 are shown as distributed around a fiber containing a core 3. As shown, the entire bundle 5 is fused and tapered 7 to a single output fiber 9. As described in DiGiovanni, tapering of the fiber bundle is performed to increase the pump light that can be coupled into the end of the double clad fiber. As the numerical aperture (hereinafter NA) of the multimode pump region of the double clad fiber is typically much larger than the NA of the pump fibers, tapering of the fiber bundle allows an increase in the optical pump intensity while remaining within the angular acceptance of the multimode pump region.

While the previously developed coupling architectures have proven somewhat successful in coupling pumping optical pumping radiation to one or more fiber lasers or amplifiers a number of shortcoming have been identified. For example, coupling power scaled, single mode polarized outputs to one or more fiber lasers or amplifiers has proven problematic. For example, tapering of the fiber optic devices is a time consuming and expensive process. Further, the core of the device must be tapered in the same ratio as the pump fibers during the tapering and fusing process. When using a single mode core, the tapering of the core may result in a dramatic variation in the optical mode field diameter propagating through the taper region. Further, recently a number of specialty fiber optics devices have been developed, including polarization maintaining (PM) fiber cores, holey fibers and fibers with multiple or ring cores. For example, FIG. 2 shows a cross-sectional view of a PM fiber 11 where the polarization maintaining property is achieved by means of birefringent stress rods 13 positioned proximate to a fiber core or optical field 15. As such, these recently developed specialty fiber optic devices may present significant challenges when utilized in a system having a tapered core geometry.

Thus, in light of the foregoing, there is an ongoing need for a method and apparatus for coupling the optical radiation received from at least one pump source into at least one fiber laser or amplifier.

### SUMMARY

Various embodiments of fiber amplifiers and related devices are disclosed herein. In one embodiment, a fiber amplifier is disclosed and includes a fiber amplifier body comprising a core of a first diameter, at least one signal conduit in optical communication with a signal source and the fiber amplifier body, the signal conduit sized to the first diameter, and one or more pump conduits configured to propagate pump radiation to the fiber amplifier body, the pump conduits in optical communication with at least one pump source.

Other features and advantages of the embodiments of the fiber amplifiers as disclosed herein will become apparent from a consideration of the following detailed description.

### BRIEF DESCRIPTION OF THE DRAWINGS

Various polarization rotation elements will be explained in more detail by way of the accompanying drawings, wherein:

FIG. 1 shows a fused tapered fiber bundle for spatially multiplexing pump and signal into a double clad fiber;

FIG. 2 shows an embodiment of a fiber core at the input of the fused, tapered fiber optic bundle;

FIG. 3 shows a schematic diagram of an embodiment of a fiber amplifier for amplifying an input signal;

FIG. 4 shows a cross-section view of an embodiment of a fiber optic bundle for use with the fiber amplifier shown in FIG. 3;

FIG. 5 shows a schematic diagram of an alternate embodiment of a fiber amplifier for amplifying an input signal;

FIG. 6 shows a diagram of a prior art fiber amplifier system having a tapered configuration;

FIG. 7A shows a schematic diagram of another embodiment of a fiber amplifier system having a single end pumping configuration; and

FIG. 7B shows a schematic diagram of another embodiment of a fiber amplifier system having a dual end pumping configuration;

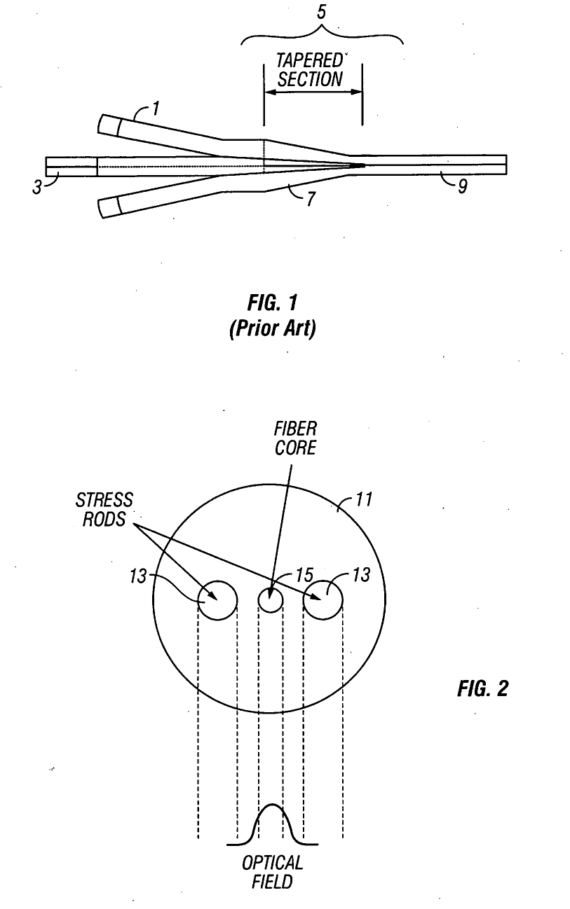

### DETAILED DESCRIPTION

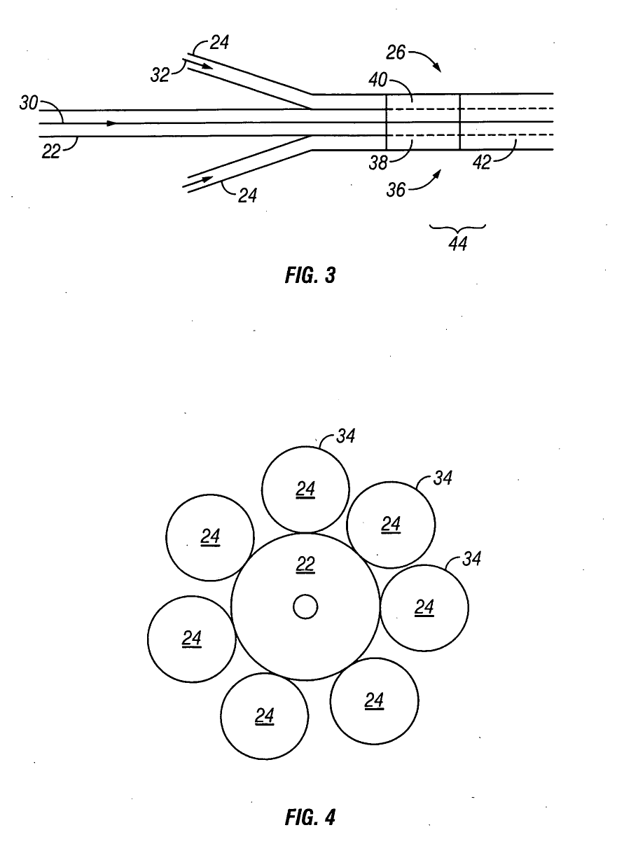

FIGS. 3-4 show various embodiment of fiber optic amplifier. As shown, the fiber optic amplifier 20 includes at least one signal conduit 22 and one or more pump conduits 24 positioned proximate thereto. In the illustrated embodiment, the at least one signal conduit 22 is encircled by 7 pump conduits 24. Optionally, any number of pump conduits 24 may be positioned radially about the signal conduit 22. For example, a multiplicity N of individual pump conduits 24 and one or more signal conduits 22 may be fused into a N+1 pump bundle. As shown in FIG. 3, at least one cross-sectional dimension of the signal conduit 22 is constant. For example, in the illustrated embodiment the diameter of the signal conduit 22 is remains substantially unvaried within the fiber amplifier region 26 as compared with regions before 28 (of after) the fiber amplifier region 26. Optionally, the pump conduits 24 may or may not have a constant transverse dimension within the fiber amplifier region 26 as compared with regions before 28 (of after) the fiber amplifier region 26. For example, in one embodiment the pump conduits 24 are tapered within region 28, thereby having a smaller transverse dimension within the amplifier region 26 as compared with the region 28. In an alternate embodiment, the pump conduits 24 have a constant transverse dimension.

Referring again to FIG. 3, the signal conduit 22 may be configured to propagate one or more signals 30 therein. For example, in the illustrated embodiment the signal conduit 22 may propagate a single signal 30 therein. As such, the signal conduit 22 may comprise a single mode fiber optic device. In an alternate embodiment, the signal conduit 22 may be configured to propagate multiple signals 22 therein simultaneously. For example the signal conduit 22 may be used in a dense wavelength division multiplexed (DWDM) architecture. As such, the signal conduit 22 may comprise a multiple mode fiber optic device. Similarly, the pump conduits 24 may be configured to provide optical radiation 32 to the fiber amplifier 20 and may comprise single mode or multiple mode fiber optic devices. For example, in the illustrated embodiment the pump conduits 24 comprise one or more multiple mode fiber optic devices configured to propagate multiple modes of optical radiation simultaneously. As such, the pump conduits 24 may be configured to carry high power optical pump radiation from any number and variety of optical pump radiation sources. Exemplary pump radiation sources include, without limitation, laser diode emitters, stacks, and bars; gas lasers, solid state lasers, slab lasers, semiconductor devices, and other sources of optical radiation. In an alternate embodiment, the pump conduits comprise one single mode fiber optic devices configured to propagate a single mode of optical radiation. Optionally, the plurality of single mode and multiple mode fiber optic devices may be used simultaneously.

Optionally, the spatially multiplexed pump bundle may be spliced to a fiber optic section. For example, as shown in FIGS. 3 and 4 when scaling to high powers the pump bundle 34 may be spliced to a high NA double clad (DC) fiber section 36, thereby confining the pump light to the inner clad region 38 and the signal 30 to the core 40. Optionally, the core 40 in this DC end section 38 may be formed from doped or undoped materials. Thereafter, the fiber section 36 may be spliced to a DC fiber amplifier 42 of near-identical dimensions with the core 40. In one embodiment used in high power applications, shorter fiber amplifiers may be required to limit interference and losses due to parasitics and non-linear effects. As such, the core 40 may have a large mode area (LMA), typically on the order of about 1□m to about 100□m in transverse dimension. For example, in one embodiment the core 40 may have a transverse dimension of about 20□m to about 30□m. However, the maximum transverse dimension of the core 40 may be dictated by output mode requirements. Single mode performance from DC fibers was successfully demonstrated for cores as large as about 35 μm. For example, multimode outputs may be obtained using cores 40 having a larger transverse dimension. Generally, the larger transverse dimensions of the core 40 results in greater core-to-clad ratios allowing the pump light to be fully coupled into the core 40 over a relatively shorter length. Therefore, the coupling region 44 may be configured to couple the pump fibers 24 into a clad region 38 and the signal mode 22 into the LMA core 40 of the amplifier fiber. As a result, the resulting output mode profile may be correspondingly larger than the input signal mode.

Referring again to FIGS. 3 and 4, those skilled in the art will appreciate the coupling architecture described herein may be capable of accommodating a mode fill transformation feature with minimal losses. As such, the combination techniques taught herein allows the pump fiber bundle 34 to be simply heated and fused into a single DC fiber amplifier 42, effectively eliminating the need for tapering the whole bundle thereby reducing manufacture time and expense. Further, the coupling devices and methods disclosed herein may be adapted to support high power pumping of many different types of specialty fiber architectures including, in particular, those with PM fiber cores. More specifically, the fiber core and the signal mode field transverse dimension are continuously maintained through the entire length of the fiber amplifier bundle, thereby eliminating the tapered section. As such, this architecture is well suited for scaling linearly polarized output power from end-pumped double-clad fibers since the PM properties of the fiber core are preserved throughout the entire fiber bundle. In particular designs where the PM property is achieved by way of incorporating two birefringent stress rods, corresponding to the standard PANDA configuration, the technique involving direct fusing circumvents any issues due to interference with the stress rods. In addition to forming a more robust device, the single fiber interface to the resulting fiber amplifier configuration using direct fusing of the pump fiber bundle to the amplifier fiber as described herein has an added benefit of eliminating space between the stacked fibers, thereby increasing the overall optical brightness of the source.

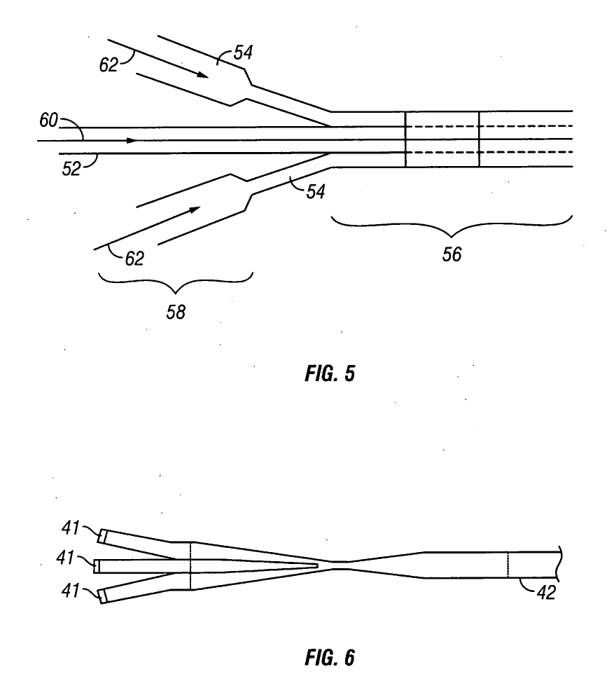

FIG. 5 shows an alternate embodiment of a fiber amplifier configuration. As shown, the fiber amplifier 50 includes at least one signal conduit 52 and one or more pump conduits 54 positioned proximate thereto. Like the previous embodiment, any number of pump conduits 54 may be positioned radially about the signal conduit 52. As shown in FIG. 5, at least one cross-sectional dimension of the signal conduit 52 remains constant. For example, in the illustrated embodiment the diameter of the signal conduit 52 remains substantially unvaried within the fiber amplifier region 56 as compared with regions before 58 (of after) the fiber amplifier region 56. In contrast to the previous embodiment, the pump conduits 54 taper proximate to the fiber amplifier region 56 as compared with regions before 58 (of after) the fiber amplifier region 56.

Referring again to FIG. 5, the signal conduit 52 may be configured to propagate one or more signals 60 therein. For example, in the illustrated embodiment the signal conduit 52 may propagate a single signal 60 therein. As such, the signal conduit 52 may comprise a single mode fiber optic device. In an alternate embodiment, the signal conduit 52 may be configured to propagate multiple signals 52 therein simultaneously. For example the signal conduit 52 may be used in a dense wavelength division multiplexed (DWDM) architecture. As such, the signal conduit 52 may comprise a multiple mode fiber optic device. Similarly, the pump conduits 54 may be configured to provide optical radiation 62 to the fiber amplifier 50 and may comprise single mode or multiple mode fiber optic devices. For example, in the illustrated embodiment the pump conduits 54 comprise one or more multiple mode fiber optic devices configured to propagate multiple modes of optical radiation simultaneously. As such, the pump conduits 54 may be configured to carry high power optical pump radiation from any number and variety of optical pump radiation sources. Exemplary pump radiation sources include, without limitation, laser diode emitters, stacks, and bars; gas lasers, solid state lasers, slab lasers, semiconductor devices, and other sources of optical radiation. In an alternate embodiment, the pump conduits comprise one single mode fiber optic devices configured to propagate a single mode of optical radiation. Optionally, the plurality of single mode and multiple mode fiber optic devices may be used simultaneously.

Referring again to FIG. 5, those skilled in the art will appreciate that the present embodiment having tapered pump fibers may be used to drive a PM fiber amplifiers. For example, a multimode fiber for conducting pump radiation 32 may have a large transverse dimension and a lower NA. Optionally, the pump fibers 54 may include a numerical aperture transformer comprising an adiabatic taper designed to achieve higher power density for the pump radiation as required to match to a typical high NA fiber amplifier. In an alternate embodiment, any number of other techniques may be used to transform the numerical aperture of the pump fiber 54. For example, a prior art configuration taught by Fidric et al in U.S. Pat. No. 6,434,302, which is incorporated by reference in its entirety herein, and shown in FIG. 6 of the present application may be beneficially utilized in the present embodiment as a method to provide the requisite multimode pump fiber. In this approach, a high NA pump fiber 54 is formed by the fused tapered bundling of a number of lower NA multimode pump fibers which do not generally have to contain a fiber core. This configuration allows combining light from a plurality of multimode laser sources into a single multimode fiber of higher NA thereby providing also an effective way to further scale up the input power levels used to pump the fiber amplifier. Such an approach may be well suited to the combination of multiple single emitter semiconductor lasers, or the combination of several emitter elements from a semiconductor laser bar. Furthermore, this can be done using, for the most part, commercial parts, since an optical coupler based on these principles is available from JDSU. In alternate embodiments, the semiconductor pump laser could be coupled directly into a high NA delivery fiber using high NA pump coupling optics such as LiMO lenses and the like, which are known in the art of fiber coupling. In still other approaches, the pump fibers may comprise a high NA fiber laser, or else the fibers may be entirely absent with the pump radiation imaged directly onto the double clad fiber. All such techniques for coupling light into pump fibers with the high NA properties required to couple into a clad region of the fiber amplifier are considered as falling within the scope of the present invention.

Referring again to FIG. 5, in an alternate embodiment low index glass claddings may be preferred over the more conventional polymer claddings. As such, the NA of the inner cladding of the fiber amplifier may be in the range of about 0.05 to about 0.35. For example, the NA of the inner cladding of the fiber amplifier may be in the range of about 0.21-0.22. As a result, brightness enhancement of the pump fibers may not be required. Further, the fused fiber bundle may need no further optimization or transformation of the NA. Thus, special cases such as glass clad fibers or any similar configuration wherein the NA of the inner clad is matched to the NA of the pump fibers all fall within the scope of the present invention.

Those skilled in the art will appreciate that the end-pumped configuration shown in FIG. 5 permits thet output power from the DC fiber amplifier to be scalable in proportion to the number of pump fibers 54 that can be arrayed in the bundle around the signal conduit 52 (in addition to the available power from each diode pump source). Yet, increasing the number of pump fibers 54 must be accomplished in a way that is consistent with compact packaging of the entire fiber amplifier system 50. In one embodiment, the fiber bundle footprint may be manufactured by removing, reducing or otherwise etching down the pump cladding while maintaining the transverse diameter of the signal conduit 52. In an alternate embodiment, pump claddings having smaller transverse dimensions to non-circular profiles such as the optical fibers used for tight bend radius gyroscope applications may be incorporated into the device shown in FIG. 5.

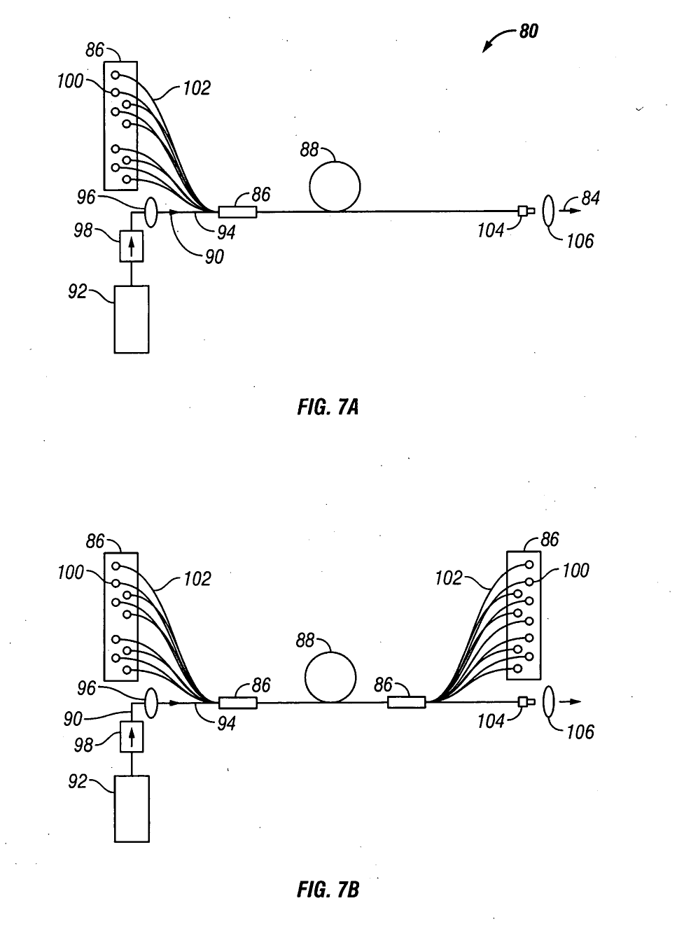

FIGS. 7A-7C show alternate embodiments of fiber amplifiers. As shown in FIG. 7A, the fiber amplifier system 80 may form a Master Oscillator, Fiber Power Amplifier (MOFPA) configuration suitable for scaling the power or energy from a signal 82 to much higher levels while maintaining or selecting the mode properties of scaled up output 84. In this configuration, a fused pump combiner 86 may be used to end pump one or more fiber amplifiers. In the illustrated embodiment, a single fiber amplifier 88 is included in the MOFPA 80. Optionally, any number of fiber amplifiers 88 may be used. Referring again to FIG. 7A, optical radiation 90 is provided to the fused pump combiner 86 as an input signal. In one embodiment, the signal 90 is supplied by a seed laser 92 (hereafter labeled a Master oscillator (MO)). The output of the MO 92 is optically coupled into a signal fiber 94 using a lens system or telescope designated 96. In one embodiment, the signal 90 is single mode. As such, the signal fiber 94 may comprise a single mode signal fiber. At least one isolator 98 may be included to prevent leakage back into the seed MO 92. One or more pump sources 100 are coupled into pump fibers 102 which are bundled and fused to the signal fiber 94 as was described above. For example, FIG. 7A shows a single end pumping architecture wherein a single group of pump sources 100 are used. In an alternate embodiment, FIG. 7B shows a dual end pumping configuration having two groups of pump sources 100 located within the system. Optionally, any number of pump sources 100 may be included.

Optionally, the pump fibers 102 may be single or multiple mode fibers. Further, the pump fibers 94 may be pre-tapered or several fibers may be combined to provide the requisite NA for coupling into the fiber amplifier 88. The amplifier 88 may comprise a DC fiber or any variety of micro-structured, holey or photonic fibers. Optionally, the fiber amplifier 88 may be selected to be compatible with shorter lengths to suppress undesirable interference from non-linear effects and parasitics. Further, it may be desired that the fiber be PM as well as a LMA Yb-doped fibers with output of about 1.03 μm to about 1.11 μm. The output from the fiber amplifier 88 may be terminated with a ferrule 104 and may be followed by collimating optics 106 or the like.

As shown in FIG. 7A the diode laser sources may comprise any number N of single emitters configured to output a desired wavelength and mounted on in a module comprising at least a heat sinking rack which typically includes a thermal interface and driven by power supply which also contains temperature control electronics. For example, when pumping Yb-doped fiber, the pump radiation may have a wavelength of about 915 nm to about 980 nm, depending on availability, cost and power consumption requirements. Optionally, any number and type of pump sources may be used including, without limitation, gas lasers, slab lasers, semiconductor devices, and the like.

The MO 92 providing the signal determines, in large part the modal properties of the output, and may comprise a CW, Q-switched or a mode locked source. It may comprise a diode, a diode pumped solid state laser, including one of several varieties of microchip lasers, or another fiber laser. As such, the signal wavelength may fall within the gain bandwidth of the fiber amplifier. Further, the MO 92 may produce output powers ranging from a few mW to about 100 mW.

With fiber amplifier pumping efficiencies of 60% already demonstrated, it can be seen that the end-pumping configuration shown in FIG. 7B may be capable of providing in excess of 100 W output, assuming again, pumping from both ends of the fiber amplifier. It is further noted that utilization of a larger core PM fiber (25-30 μm for the active core) such as the 125 mm clad fibers available from NuFern, makes the disclosed design suitable for pulsed operation, yielding linearly polarized outputs of well over 1 mJ at repetition rates on the order of 10-100 kHz with excellent beam quality. This will make the MOFPA disclosed herein highly competitive with the highest performance levels currently achievable from bulk diode pumped solid state lasers. The availability of still more pump power (following projections from semiconductor laser manufacturers), would make it possible to scale the output power from a single double clad fiber amplifier even further to >300 W, still using state of the art technology diodes and fibers, all from a highly compact and robust design. Even greater power scaling is feasible by setting up fiber amplifiers in series or using beam combining methods to reach kW output levels. Such power scaling techniques and known variations thereof that utilize the basic fiber bundle pumped amplifier concept described herein as a building block therefore fall within the scope of the present invention.

The basic capabilities of the pumping configuration of the disclosed herein hve been proven during experimentation utilizing a 12 diode pump module, delivering about 5 W from each of 12 105/125 μm 0.22 NA pump fibers. The pump fibers were tapered prior to being fused with the centrally located signal fiber as was discussed earlier with little or no loss, thereby providing up to about 60 W to one end of the fiber amplifier. A standard diode pumped Nd-doped vanadate laser could be used as the MO, such as the Spectra-Physics BL10 or BL20 model. These lasers can provide upward of 1W at 1064 nm of pulses at repetition rates between 10 and 100 kHz with corresponding pulse durations between 5 and 20 ns and low <2% noise characteristics. This signal is typically attenuated to just under 100 mW prior to coupling into a single mode fiber. Using a 30 μm core, 250 μm clad fiber from NuFern the pump coupling technique of the invention provided power outputs in excess of up to 40W with a slope efficiency of over 60%. The amplifier showed excellent linearity across the full measurement range without roll over even at higher gains of over 20 dB and the average power output could be increased linearly with the MO repetition rate as predicted. Furthermore, this output was observed to be over 90% linearly polarized if a PM fiber amplifier was utilized. Ultimately, it is expected that with optimal PM fiber designs, polarization extinctions in excess of 15 dB will be obtained using linearly polarized signal input.

Embodiments disclosed herein are illustrative of the principles of the invention. Other modifications may be employed which are within the scope of the invention. Accordingly, the devices disclosed in the present application are not limited to that precisely as shown and described herein.

1. A fiber amplifier, comprising:
a fiber amplifier body comprising a core of a first diameter;
at least one signal conduit in optical communication with a signal source and the fiber amplifier body, the signal conduit sized to the first diameter; and
one or more pump conduits configured to propagate pump radiation to the fiber amplifier body, the pump conduits in optical communication with at least one pump source.

2. The device of claim 1 wherein the signal conduit is fused to the fiber amplifier body.

3. The device of claim 1 wherein the signal conduit comprises a single mode optical fiber.

4. The device of claim 1 wherein the pump conduits comprise multiple mode fiber optics.

5. The device of claim 1 wherein the pump conduits are fused to the fiber amplifier body.

6. The device of claim 1 wherein the pump conduits are in optical communication with one or more laser diodes.

7. The device of claim 1 wherein the pump conduits are tapered.

8. The device of claim 1 wherein at least two pump sources are in optical communication with the fiber amplifier body.
